(19) United States
(12) Patent Application Publication
(10) Pub. No.: US 2015/0208588 A1
(43) Pub. Date: Jul. 30, 2015

(54) Lawn Roller Device for Removing Lawn Debris

(71) Applicant: Chuck Cady, North Platte, NE (US)

(72) Inventor: Chuck Cady, North Platte, NE (US)

(21) Appl. No.: 14/607,128

(22) Filed: Jan. 28, 2015

Related U.S. Application Data
(60) Provisional application No. 61/932,356, filed on Jan. 28, 2014.

(51) Int. Cl. A01G 1/12

(52) U.S. Cl. CPC A01G 1/125

(57) ABSTRACT

A lawn roller device is provided that is configured to retrieve and remove sand burrs and lawn briars from a lawn surface using a roller having a fibrous material outer layer. The device comprises a roller having one or more wheels supporting a cylindrical body, over which is supported a removable fibrous material outer layer. The roller is supported on an axle and is pulled or pushed using frame and shaft portion. The shaft portion supports a handle member, or alternatively is secured to a hitch of a motorized landscaping vehicle and pulled over the surface of a lawn. The device is sufficiently weighted and the fibrous material is such that sand burrs and lawn briars adhere thereto upon contact, whereby the lawn is cleaned of these items and the fibrous material can be removed and cleaned after each use.

### CROSS REFERENCE TO RELATED APPLICATION

This application claims the benefit of U.S. Provisional Application No. 61/932,356 filed on Jan. 28, 2014. The above identified patent application is herein incorporated by reference in its entirety to provide continuity of disclosure.

### BACKGROUND OF THE INVENTION

1. Field of the Invention

The present invention relates to lawn rollers and landscaping tools. More specifically, the present invention relates to a lawn roller assembly having a fibrous outer surface that is adapted to adhere to and collect sand burrs and lawn briars from a lawn surface when the device is rolled thereover.

Many homeowners and businesses take pride in the exterior appearance of their property, employing manpower and specific tools to properly clean and landscape the same. Maintained lawns or other open areas improve the aesthetics of the property and promote pride in the home or business. To properly landscape lawns and gardens, many tools and device have been developed in the art, ranging from large lawn mechanical assemblies to hand tools for cultivating and trimming.

One common tool in the art that is used for both landscaping and for agricultural purposes is a lawn roller. Lawn rollers are elongated and weighted cylinders that are generally towed by a vehicle or pushed by a user to flatten terrain or compact soil. The cylinder has a given weight and is used to compact the underlying soil below the grass, thereby flattening an area and forcing recently laid seeds into the soil if the season is appropriate.

The present invention relates to a roller-type apparatus, but for an alternative purpose and using an alternative structural configuration. Notably, the present invention is not directed to flattening out a lawn, but rather to collecting sand burrs, lawn briars, grass stickers, and other vegetation that may have dropped onto the lawn prior to or after the lawn is mowed. Removing these items is particularly difficult because they can accumulate and require individual removal. These items tend to stick to knitted cloth material, such as gloves and clothing items, so these items are difficult to pick up and deposit into a container or receptacle.

An alternative to individual removal is to mow over the entire area to mulch and eviscerate the unwanted vegetation. However, this can spread the vegetation and cause it to distribute across a larger portion of the lawn. Since most of this vegetation is considered a weed, more considered removal is warranted to prevent spreading and to prevent future occurrence of regrowth. The present invention is directed to an apparatus that is rolled along the lawn to collect these items individually, whereby the device takes advantage of the tendency of this sticker type vegetation to collect and subsequently remove the same from a lawn.

Specifically, the present invention comprises a lawn roller device having a frame supporting a roller assembly and an elongated handle. The elongated handle can support a handlebar cross member, or furthermore be secured to the two hitch of a tractor, lawn mower or similar vehicle. The roller assembly comprises a rotatable assembly having one or more wheels surrounded by a cylindrical surface. The surface supports a removable layer of fibrous material that is adapted to affix sand burrs, lawn briars, grass stickers and other vegetation thereto upon contact. The user rolls or tows the assembly over a lawn to retrieve the unwanted vegetation, which collects on the outer layer. The outer layer can then be scraped clean or discarded to dispose of the unwanted lawn debris.

2. Description of the Prior Art

Devices have been disclosed in the prior art that relate to landscaping assemblies and lawn rollers. These include devices that have been patented and published in patent application publications. These devices generally relate to weighted lawn rollers or devices designed for alternative purposes than that proposed herein. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,290,619 to Maas discloses a soil aeration device that includes a plurality of tines disposed on shafts, which are furthermore supported on a rotatable assembly drawn behind a powered vehicle. The aeration device includes a rotatable mechanism and gear train for the treatment of lawns, whereby the device is rolled over the lawn to puncture the soil and allow air penetration thereinto. While concerned with landscaping and providing a rotatable assembly, the Maas device fails to contemplate a rotatable assembly having a fibrous outer surface. The present invention is directed to a landscaping device that adheres to sand burrs and lawn briars, thereby collecting them along the fibrous surface for subsequent removal and cleaning of an outdoor space.

Similar to Maas is U.S. Pat. No. 4,619,329 to Gorbett, which discloses another soil aerator having a rotatable drum mounted to a vehicle-towable frame. The drum comprises an outer surface having a plurality of triangle-shaped teeth in which to engage and penetrate the soil, whereby the drum rotates as the frame is towed. As with Maas, the Gorbett device provides a rotatable drum but for a divergent concern as compared to the purposes of the present invention. The structure of Gorbett similarly fails to anticipate the assembly of the present invention.

U.S. Pat. No. 2,580,084 to Donnelly discloses a lawn roller assembly that is utilized to apply contact pressure to a turf surface in order to flatten the blades of grass in preparation of cutting the same. The assembly comprises an enlarged cylinder having a hollow interior that can be filled with a weighted medium. The roller is supported by a shaft that attaches to a handle. The user presses or pulls the handle to roll the weighted cylinder along a turf surface. While the Donnelly devices comprises a lawn treatment device having a roller, it fails to contemplate an assembly that can adhere to and remove sand burrs, briars and other sticker type foliage that may be littered across a lawn surface. The present invention can be rolled over the lawn surface to retrieve these items without personally handling each, providing a means to clean up and beautify a lawn, or prepare the same for subsequent mowing operations.

Similar to Donnelly, U.S. Pat. No. 1,286,564 to Dunham discloses an advancement on lawn rollers that deploys a scraper across the top of a cylindrical lawn roller assembly. The assembly includes a handled portion in connection with a rotatable cylinder used to roll over a lawn. Between the frame of the handle and the roller surface is a spring biased scraper element to remove debris from the surface of the roller. The Dunham device, while improving the lawn roller, fails to disclose a structure in which would be suitable for collecting sand burrs and lawn briars as contemplated herein.

Finally, U.S. Pat. No. 5,005,844 to Douglas provides a rolling travois that is drawn behind a walking user for supporting the weight of equipment and other heavy items. The assembly comprises a pulling harness worn by the user, a pivotably connected frame, and a rear roller assembly. Similarly to the aforementioned devices, the Douglas device fails to anticipate the utility of the present invention. The Douglas device provides a means of pulling a wheeled assembly, yet fails to contemplate a roller assembly for collecting sand burrs and lawn briars while landscaping.

The present invention contemplates a lawn roller device that is not used to lay sod or flatten the topography of a lawn, but rather to be used as a device to remove lawn debris and fallen vegetation. The device comprises a lawn roller structure having a roller with an outer layer of fibrous material. The fibrous material includes woven and looped material that readily adheres to sticker debris, lawn briars, and sand burrs that are present on a lawn surface. The roller device is pushed or pulled over the surface of the lawn, and upon contact with these items, allow the items to affix themselves to the surface of the fibrous material for subsequent removal. The structure of the present invention allows for manual use or use in conjunction with a powered vehicle.

It is submitted that the present invention substantially diverges in design elements from the prior art, and consequently it is clear that there is a need in the art for an improvement to existing lawn roller devices. In this regard the instant invention substantially fulfills these needs.

### SUMMARY OF THE INVENTION

In view of the foregoing disadvantages inherent in the known types of lawn rollers now present in the prior art, the present invention provides a new landscaping tool wherein the same can be utilized for providing convenience for the user when removing sticker vegetation, lawn briars, and sand burrs from a lawn surface.

It is therefore an object of the present invention to provide a new and improved lawn roller device that has all of the advantages of the prior art and none of the disadvantages.

It is another object of the present invention to provide a lawn roller device that is used as a lawn debris removal device that eliminates manual removal of individual vegetation, and eliminates any necessity to mulch the vegetation while mowing the lawn.

Another object of the present invention is to provide a lawn roller device that includes a sufficiently weighted roller and a fibrous material outer layer, whereby sticker vegetation and the like readily adhere to the outer layer of the roller for removal purposes.

Yet another object of the present invention is to provide a lawn roller device to allow the fibrous outer layer to be removable for cleaning and for replacement.

Another object of the present invention is to provide a lawn roller device that can be manually driven or pulled behind a motorized vehicle.

A final object of the present invention is to provide a lawn roller device that is fabricated from materials that permit relative economy and that are commensurate with durable use as a landscaping tool.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the lawn roller of the present invention.

FIG. 2 shows another view of the lawn roller of the present invention.

FIG. 3 shows the elements of the lawn roller of the present invention.

FIG. 4 provides an illustrative view of the lawn roller being manually driven.

FIG. 5 is an illustrative view of the lawn roller being hauled by a motorized landscaping vehicle.

### DETAILED DESCRIPTION OF THE INVENTION

Reference is made herein to the attached drawings. Like reference numerals are used throughout the drawings to depict like or similar elements of the lawn roller of the present invention. For the purposes of presenting a brief and clear description of the present invention, the preferred embodiment will be discussed as used for retrieving and removing sticker vegetation, lawn briars, and sand burrs from a lawn while landscaping. The figures are intended for representative purposes only and should not be considered to be limiting in any respect.

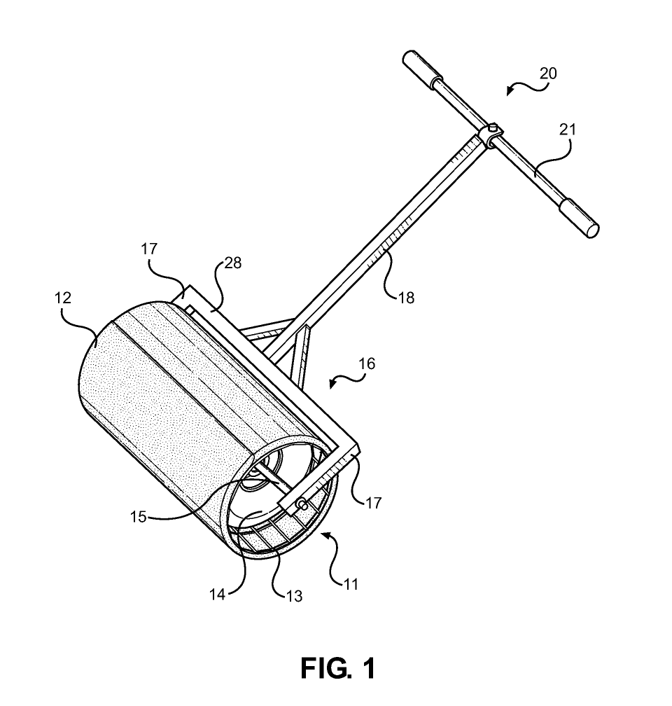

Referring now to FIG. 1, there is shown a perspective view of the lawn roller device of the present invention. The device comprises a roller assembly 11 mounted on an axel 15 and supported from a roller frame 16. The roller assembly 11 is a weighted, cylindrical body that supports a fibrous outer layer 12 thereon. The roller assembly 11 comprises a cylindrical sidewall 13 that may comprises a continuous surface or may comprises an open mesh (as presented in FIGS. 1 through 3), whereby the fibrous outer layer 12 secures over the sidewall 13 of the roller. In operation, the roller is pushed or pulled, whereby the roller assembly 11 rotates and the surface of the outer fibrous layer 12 contacts the ground surface to retrieve stickers and similar vegetation.

The roller frame 16 comprises a clevis type support, whereby a first and second arm 17 rotatably supports the roller axle 15 therebetween. The arms 17 secure to a cross member 28, whereby the roller frame comprises a substantial U-shaped construction. From the cross member 16, an elongated shaft 18 extends therefrom. The shaft 18 is used to separate the motive input that imparts motion on the device from the roller assembly 11. The motive input is one of either a manual input or motorized vehicle input.

As shown in FIG. 1, the elongated shaft terminates at a junction 20. The junction 20 is a U-shaped clevis that supports attachment of a manual handlebar 21, or alternatively attachment to the hitch of a vehicle. The clevis secures the handlebar 21 therein using a fastener, whereby the handlebar can be pressed or pulled to impart motion on the assembly. The motion causes the roller assembly 11 to rotate, and therefore the surface of the fibrous outer layer 12 to contact the ground along a given contact patch. As the outer layer 12 contacts sticker elements and other vegetation (law briars, sand burrs, etc.), these elements affix to the fibrous material thereof. The crossbar member 28 of the roller frame 16 is offset from the outer layer 12 of the roller assembly 11, thereby allowing affixed vegetation to remain attached to the roller 11 until the landscaping activity is ceased. Moreover, the weight of the roller assembly 11 compacts the attached vegetation and further prevents separation thereof.

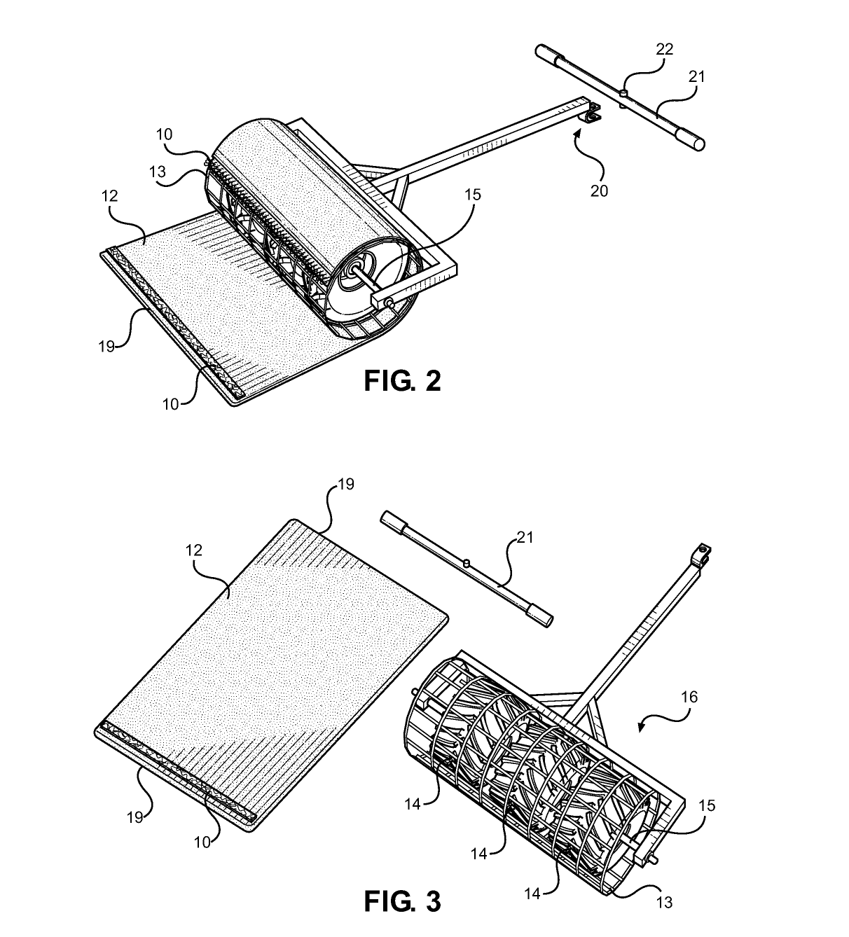

Referring now to FIGS. 2 and 3, there are shown views of the lawn roller of the present invention in partially disassembled conditions. The fibrous outer layer 12 of the present invention is an elongated length of material having an inner surface and an outer surface. The outer surface comprises a fibrous, woven material that is preferably in loops or similar pattern, and affixed to the inner surface thereof. The fibrous outer layer 12 comprises a pair of ends 19 that align and secure to one another using a hook and loop fastener line of connection 10. The layer 12 secures to itself at its ends 19, or alternatively secures to the roller surface 13.

The fibrous outer layer 12 is preferably a length of textile material, such as a carpet-like material or similar. The outer surface thereof is a textile pile, which attaches to the inner surface backing. The fibrous material is a wool or synthetic material that is formed using a looped, tufted, knotted, woven, or similar attachment pattern to its backing. The material itself and the attachment pattern allow sticker vegetation to easily adhere and be snared by the fibrous material, whereafter the sticker is compressed against the fibrous material when it passed under the roller during a full rotation thereof.

The roller comprises a cylindrical surface 13 that is continuous or open (as shown), and is supported by one or more wheels 14. The wheels are circular bodies that are rotatably supported by the device axle 15, and bridge the gap between the inner surface of the cylindrical surface 13 and the axle 15. The one or more wheels 14 may comprise solid members, or may alternatively comprise tire assemblies (as shown). The purpose of the wheels 14 is to support the roller cylindrical surface 13 and allow the axle 15 to support the same.

Similarly shown in FIGS. 2 and 3 is the detachability of the handlebar 21 and the ability of the clevis member 20 to secure the device to either a vehicle or the handlebar 21. The clevis 20 is preferably a U-shaped member that accepts therein the handlebar, after which a pin or fastener 22 secures the handlebar 21 therein. When secured to a towing vehicle, the clevis 20 can be used to secure the device to a trailer hitch receiver or similar trailer attachment.

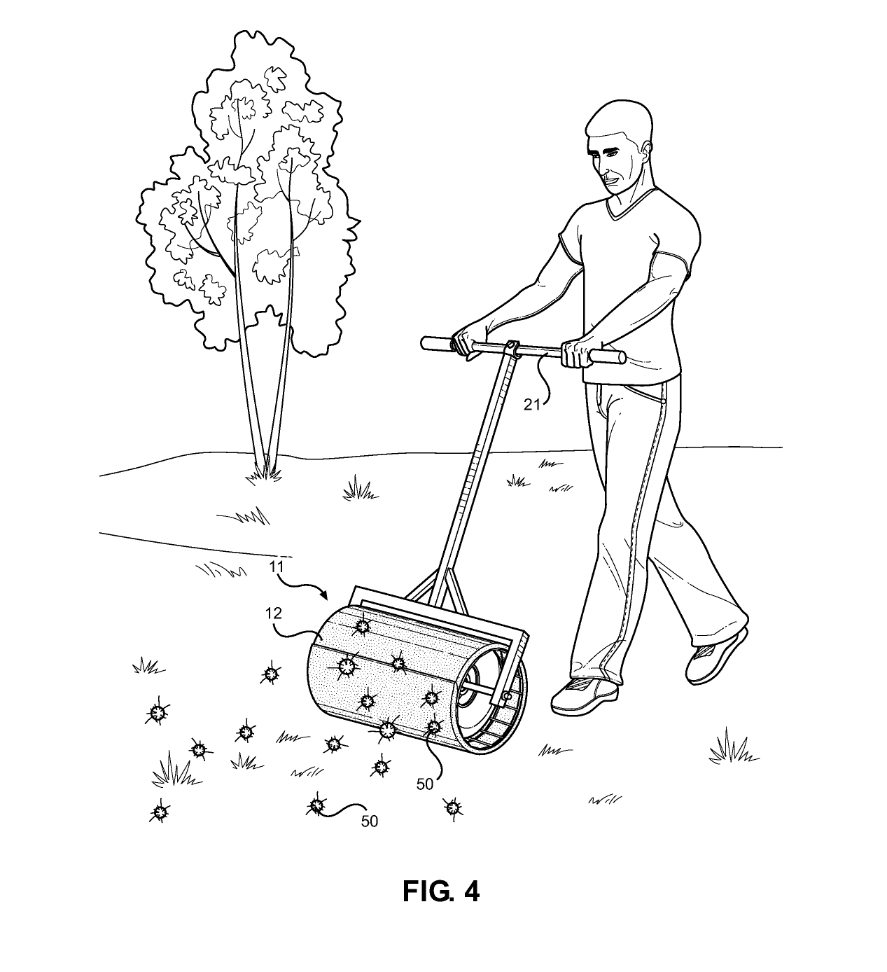

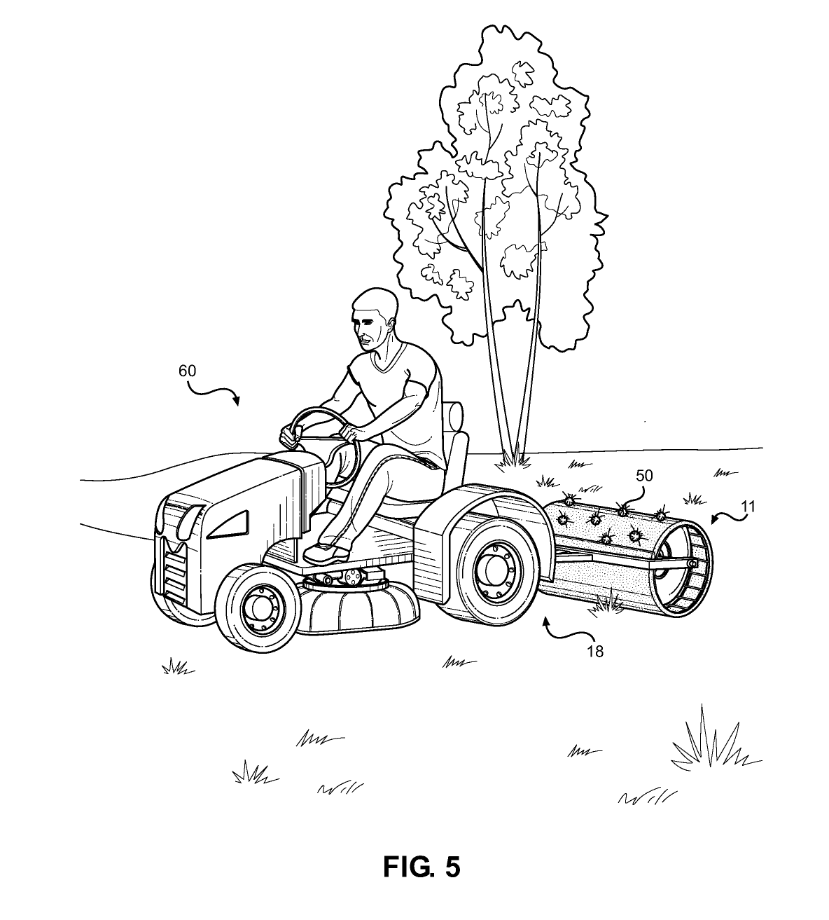

Referring now to FIGS. 4 and 5, there are shown two views of the lawn roller device of the present invention in a working state. The lawn roller device can be deployed either manually, or from the rear of a towing vehicle. When manually operating the device, the roller assembly 11 is pushed or pulled over the lawn such that its fibrous outer layer 12 can collect lawn stickers 50 and other vegetation thereon. The user grasps the handlebar 12 and imparts force on the roller frame. The attached roller assembly 11 therefore rotates and collects fallen sticker vegetation, which can be removed from the outer layer 12 after a period of use. When using the device with a towing vehicle 60, the elongated shaft 18 is affixed to the hitch of the vehicle and towed therebehind. The clevis of the shaft 18 is used to secure the roller assembly 11 to the vehicle, and the vehicle 60 tows the assembly across a lawn surface to retrieve fallen sticker vegetation.

Overall, the present invention provides a landscaping device that is adapted for collecting sand burrs and briars from lawns and outdoor spaces. The device can be used as a manual roller, or one in which a towing vehicle is deployed. The device facilitates the retrieval of lawn stickers and similar vegetation from a law, whereby the user is saved from manually picking up and discarding burrs and other vegetation from a lawn.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A lawn roller device, comprising:
a roller assembly comprising a cylindrical sidewall and an axle;
said roller assembly rotatably supported by said axle and a roller frame;
said roller frame having a crossbar member substantially parallel to said axle;
an elongated shaft extending from said crossbar member;
said crossbar member terminating at a clevis;
said clevis comprising a U-shaped member configured to support a perpendicular handlebar or be affixed to a towing vehicle;
a fibrous material outer layer removably attached to said cylindrical sidewall of said roller assembly.

2. The lawn roller device of claim 1, wherein:
one or more wheels are disposed between said axle and said cylindrical sidewall of said roller assembly.

3. The lawn roller device of claim 1, wherein:
wherein said roller frame comprises a substantially U-shaped member, wherein a first and second arm extend perpendicularly from said crossbar member.

4. The lawn roller device of claim 1, wherein:
said fibrous material outer layer further comprises an outer pile surface and an inner backing surface.

5. The lawn roller device of claim 1, wherein:
said fibrous material outer layer further comprises a first and second end, and a hook and loop fastener line of connection disposed on said first and second end.
